(19) United States
(12) Patent Application Publication
(10) Pub. No.: US 2005/0200863 A1
(43) Pub. Date: Sep. 15, 2005

(54) Printing machine with a display device for displaying printing states

(75) Inventor: Satoru Kiyohara, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG CO., LTD.

(21) Appl. No.: 11/033,389

(22) Filed: Jan. 12, 2005

(30) Foreign Application Priority Data
Jan. 29, 2004 (JP) 2004-020753
Jul. 8, 2004 (JP) 2004-201960

(51) Int. Cl. G06F 15/00

(52) U.S. Cl. 358/1.7; 358/1.14

(57) ABSTRACT

In a job selecting step executed in parallel to a printing step, a display screen 100 displays, in a setting window 201 appearing in an upper portion thereof, a plurality of job data 103a, 103b, 103c and 103d downloaded from a RIP 102 and stored in a printing machine, along with various setting keys 221. The operator selects job data for a next printing process from among these job data 103a, 103b, 103c and 103d. At this time, a printing state window 202 is displayed in a lower portion of the display screen 100. This printing state window 202 is a screen constantly displayed during printing processes.

### BACKGROUND OF THE INVENTION

1. Field of the Invention

This invention relates to a printing machine for making printing plates by recording thereon images based on image data, and then printing the images on printing paper by transferring inks applied to the printing plates to the printing paper.

2. Description of the Related Art

Generally, various settings must be made to a printing machine before starting a printing process. For this reason, printing machines proposed in recent years have a control panel of the touch panel type or the like for use in making various settings (see Japanese Unexamined Patent Publications No. 2000-215297 and 2002-113971).

While such a printing machine requires many operations to be carried out in time of starting a printing process, the control panel has reduced tasks to do once the printing process stabilizes, its remaining tasks being only to display numbers of prints completed and warnings. Thus, in reality, the control panel is not used effectively.

With a printing machine having a platemaking function for making printing plates by recording thereon images based on image data, and printing the images on printing paper by transferring inks applied to the printing plates to the printing paper, it is necessary to make settings for the platemaking besides settings for the printing. Thus, this type of printing machine requires a more time-consuming setting operation than an ordinary printing machine. Further, a printing machine constructed for measuring, in-line, colors and densities of prints, and automatically controlling ink feed rates, requires an additional time for making settings for the control of ink feed rates as well. It will be convenient if various settings for a next printing process can be made in advance, or in parallel to a printing process currently in progress.

### SUMMARY OF THE INVENTION

The object of this invention, therefore, is to provide a printing machine for enabling the operator to know a current printing state of the printing machine, and grasp abnormal parts and abnormal conditions exactly, even when entering settings for making plates for a next printing process or settings for controlling ink feed rates.

The above object is fulfilled, according to this invention, by a printing machine for making printing plates by recording thereon images based on image data, and printing the images on printing paper by transferring inks applied to the printing plates to the printing paper, the printing machine comprising an input device for setting printing conditions for a printing job in relation to the image data, a display device, and a display control device for causing the display device to display simultaneously, during a printing process, both a printing state screen showing states of the printing process in progress and a setting screen for setting printing conditions for a printing job to be carried out afterward.

With this printing machine, in parallel to a printing process currently in progress, various settings may be made for a next printing process. Thus, a control panel may be used effectively, to realize a reduced time required for an entire operation including printing and platemaking.

In a preferred embodiment, the setting screen includes any of a job selection screen for selecting the printing job to be carried out afterward, a printing information setting screen for setting printing information such as information on the printing paper and the inks and the number of prints, a platemaking information setting screen for setting platemaking information, and a color control information screen for setting color control information.

In another preferred embodiment, the printing state screen includes a completed number of prints indicator and an alarm indicator.

In a further preferred embodiment, the input device and the display device comprise a touch type control panel.

In a further preferred embodiment, the printing machine further comprises a control device for controlling a printing operation of the printing machine, and detecting abnormal parts and abnormal conditions occurring in the printing machine and parts requiring maintenance and particulars of the maintenance in the printing machine, and a storage device for storing a plurality of stereoscopic image data of the printing machine related with the abnormal parts and abnormal conditions and the parts requiring maintenance and particulars of the maintenance detected by the control device, the display device being capable of displaying the stereoscopic image data stored in the storage device, wherein the display control device is arranged to select, from the plurality of stereoscopic image data stored in the storage device, and cause the display device to display a stereoscopic image corresponding to an abnormal part and abnormal condition or a part requiring maintenance and particulars of the maintenance detected by the control device.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing machine according to this invention;

FIG. 2 is a block diagram showing a principal electrical structure of the printing machine according to this invention;

FIG. 3 is a flow chart showing a procedure from job selection to printing performed by the printing machine according to this invention;

FIG. 4 is a flow chart showing a procedure from job selection to printing by the printing machine according to this invention;

FIG. 5 is a schematic view showing a display screen of a control panel for a job selecting step;

FIG. 6 is a schematic view showing the display screen of the control panel for a job setting step;

FIG. 7 is a schematic view showing the display screen of the control panel for the job setting step;

FIG. 8 is a schematic view showing the display screen of the control panel for the job setting step;

FIG. 9 is a schematic view showing the display screen of the control panel in time of ink feed rate adjustment;

FIG. 10 is a view showing an alarm indicator in a printing state window; and

FIG. 11 is a view showing stereoscopic images of the printing machine displayed on the alarm indicator in the printing state window.

### DESCRIPTION OF THE PREFERRED EMBODIMENTS

An embodiment of this invention will be described hereinafter with reference to the drawings.

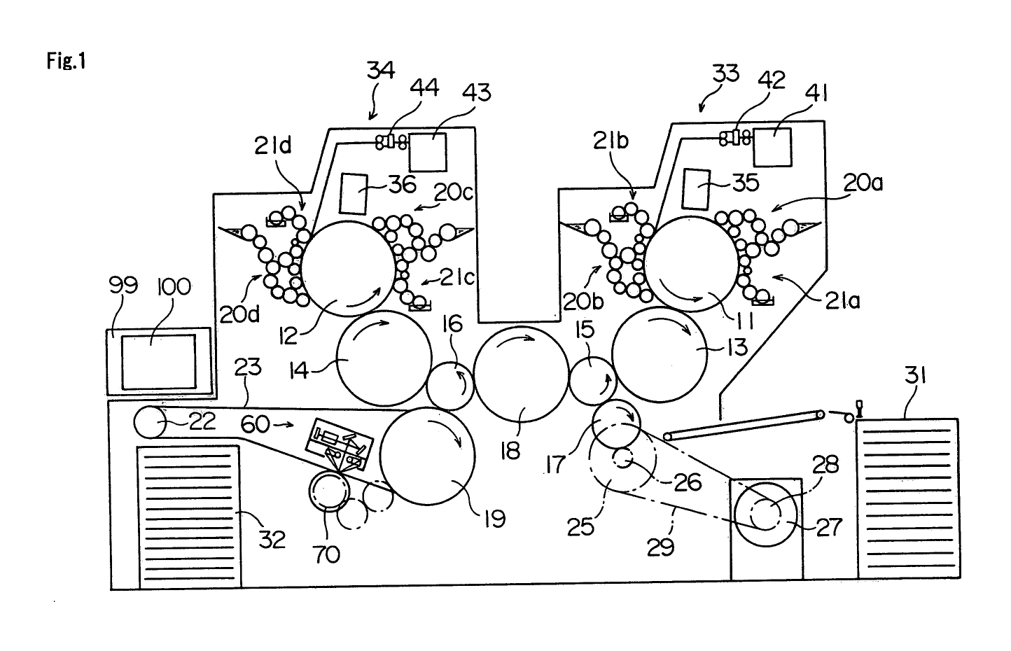

An overall construction of a printing machine according to this invention will be described first. FIG. 1 is a schematic view of the printing machine according to this invention.

This printing machine records images, based on image data, on blank plates mounted on first and second plate cylinders 11 and 12 in a prepress process, feeds inks to the plates having the images recorded thereon, and transfers the inks from the plates through first and second blanket cylinders 13 and 14 to printing paper held on first and second impression cylinders 15 and 16, thereby printing the images in four colors on the printing paper.

The printing machine has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing machine further includes a paper feed cylinder 17 for transferring printing paper supplied from a paper storage station 31 to the first impression cylinder 15, a transfer cylinder 18 for transferring the printing paper from the first impression cylinder 15 to the second impression cylinder 16, a paper discharge cylinder 19 with chains 23 wound thereon and extending to and wound on sprockets 22 for discharging printed paper from the second impression cylinder 16 to a paper discharge station 32, an image pickup station 60 for picking up images and measuring densities of detecting patches printed on the printing paper, and a control panel 99 of the touch panel type acting as a display device.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper.

The paper feed cylinder 17 disposed adjacent the first impression cylinder 15 has the same diameter as the first and second impression cylinders 15 and 16. The paper feed cylinder 17 has a gripper, not shown, for holding and transporting, with each intermittent rotation of the feed cylinder 17, the forward end of each sheet of printing paper fed from the paper storage station 31. When the printing paper is transferred from the feed cylinder 17 to the first impression cylinder 15, the gripper of the first impression cylinder 15 holds the forward end of the printing paper which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper received from the first impression cylinder 15, and transferring the forward end of the printing paper to the gripper of the second impression cylinder 16.

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having a plurality of grippers not shown. When the second impression cylinder 16 transfers the printing paper to the discharge cylinder 19, one of the grippers on the discharge cylinder 17 holds the forward end of the printing paper having been held by the gripper of the second impression cylinder 16. With movement of the chains 23, the printing paper is transported to the paper discharge station 32 to be discharged thereon.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a printing motor 27. Thus, the paper feed cylinder 17 is rotatable by drive of the printing motor 27. The first and second plate cylinders 11 and 12, first and second blanket cylinders 13 and 14, first and second impression cylinders 15 and 16, paper feed cylinder 17, transfer cylinder 18 and paper discharge cylinder 19 are coupled to one another by gears attached to ends thereof, respectively. Thus, by the drive of printing motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording, based on image data, images on the plates mounted peripherally of the first plate cylinder 11, and an image recorder 36 for recording, based on image data, images on the plates mounted peripherally of the second plate cylinder 12.

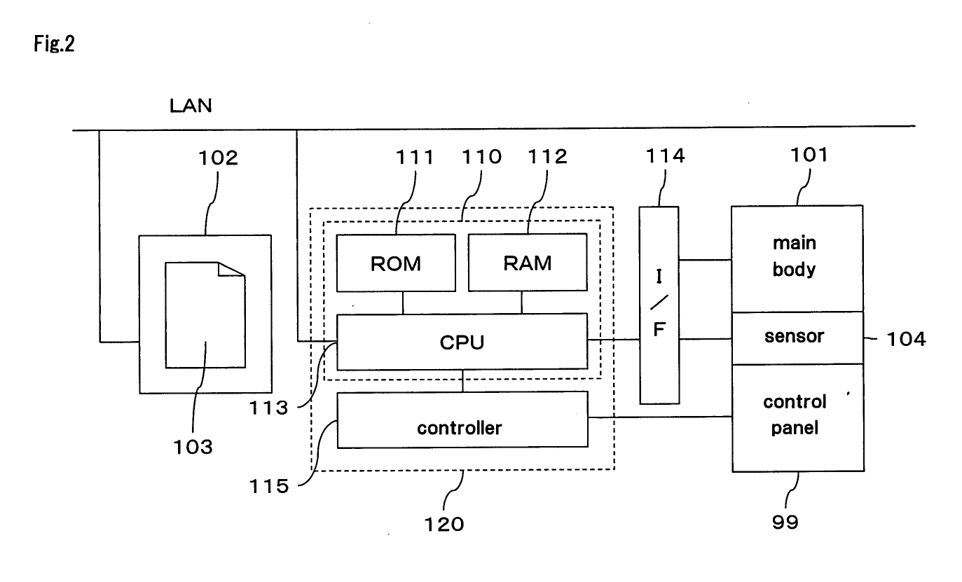

FIG. 2 is a block diagram showing a principal electrical structure of the printing machine.

This printing machine includes a control unit 110 having a ROM 111 for storing operating programs necessary for controlling the machine, a RAM 112 for temporarily storing data and the like during a control operation, and a CPU 113 for performing logic operations. The control unit 110 is connected to a main body 101 of the printing machine through an interface 114. Further, the control unit 110 is connected to the control panel 99 through a controller 115 of the control panel 99. The control unit 110 is connected also to numerous sensors 104 (only one being shown in FIG. 2). These sensors 104 can detect parts showing abnormality (hereinafter called abnormal parts) and their conditions (hereinafter called abnormal conditions). Specific examples of abnormal condition include shortage of the ink and plate material. The ROM 111 or RAM 112 stores stereoscopic image data of the printing machine relating to the abnormal parts and abnormal conditions. On the other hand, the control unit 110 manages maintenance required for every predetermined operating time or number of prints based on a maintenance program set beforehand. The control unit 110 is set to determine times when maintenance is required. The ROM 11 or RAM 12 further stores stereoscopic image data of the printing machine relating to the parts requiring maintenance (hereinafter called maintenance parts) and the particulars of maintenance operations (hereinafter called particulars of the maintenance). Specific examples of maintenance include periodical oiling and periodical cleaning.

The control unit 110 is connected through a LAN to a RIP (raster image processor) 102 that carries out a raster process of image data. This RIP 102 performs a raster process of page description language data created by a data creating device, not shown, and creates job data 103 in the form of bitmap data.

In the printing machine having the above construction, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated, the image recorder 35 irradiates the surface of the plate mounted peripherally of the first plate cylinder 11 with a modulated laser beam for recording an image thereon.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at low speed, the image recorder 36 irradiates the surface of the plate mounted peripherally of the second plate cylinder 12 with a modulated laser beam for recording an image thereon.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper is fed to the paper feed cylinder 17. The printing paper is subsequently passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper wrapped around the first impression cylinder 15 in its first rotation, and the cyan ink in its second rotation.

After the first impression cylinder 15 makes two rotations, the printing paper is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper wrapped around the second impression cylinder 16 in its first rotation, and the yellow ink in its second rotation.

The forward end of the printing paper printed in the four colors in this way is passed from the second impression cylinder 16 to the paper discharge cylinder 19. The printing paper is transported by the pair of chains 23 toward the paper discharge station 32 to be discharged thereon.

After the printing process, the printing paper printed is discharged. The first and second blanket cylinders 13 and 14 are cleaned by a blanket cylinder cleaning device, not shown, to complete the printing process.

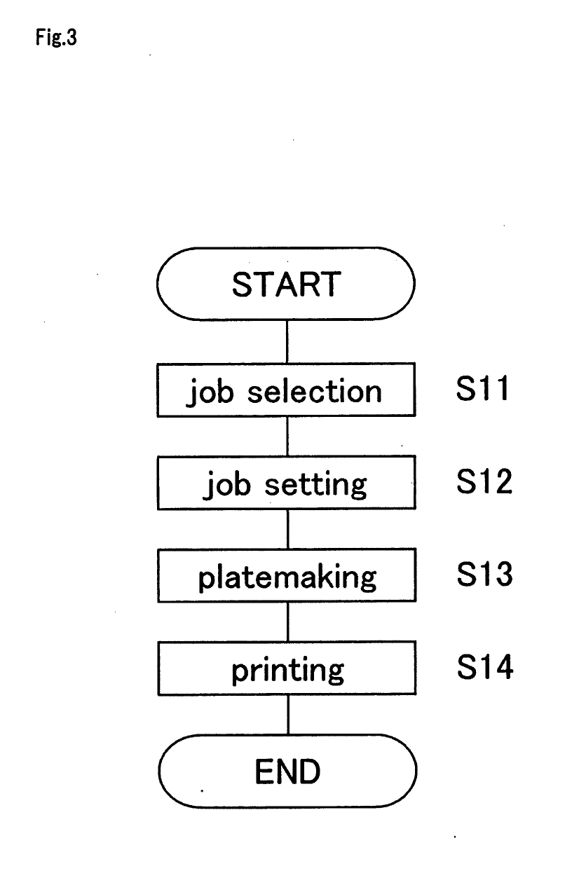

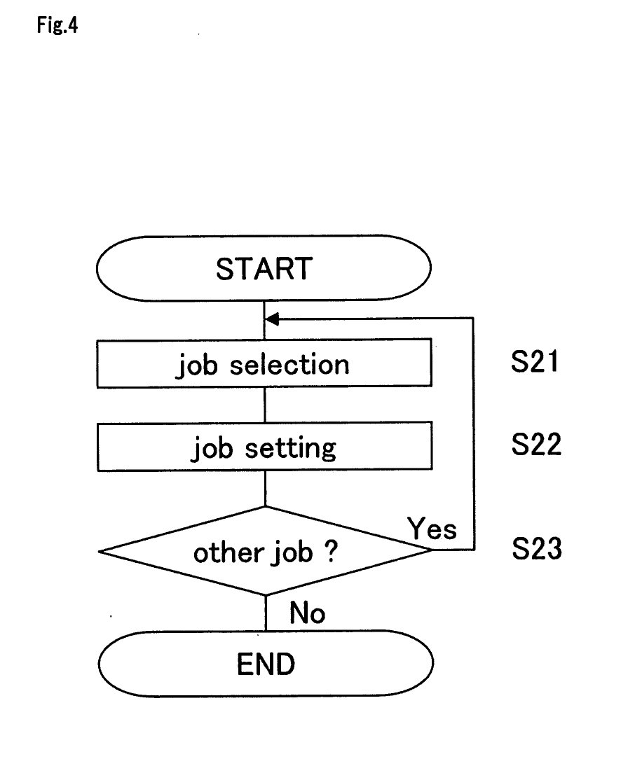

Next, a construction of this printing machine relating to job selection will be described. FIGS. 3 and 4 are flow charts showing steps from job selection to printing executed by the printing machine according to this invention.

As shown in FIG. 3, a printing job is selected first before a platemaking process and a printing process (step S11). Then, settings are made for the job (step S12). These job selecting step and job setting step will be described in detail hereinafter.

Then, printing plates are made by recording images based on image data in the operation described hereinbefore (step S13). Subsequently, a printing process is performed by using the printing plates made (step S14).

In time of the printing process noted above (step S14), the printing machine according to this invention simultaneously displays, on the control panel 99, both a printing state window showing a state of the printing process currently in progress and a setting window for setting printing conditions relating a printing job to be performed next. This allows the operator to make various settings for a next printing job to be performed, in parallel with the on-going printing process. In this way, the control panel 99 may be used effectively, thereby to shorten the time required for an entire operation including printing and platemaking.

Specifically, the process shown in FIG. 4 is performed in parallel with the platemaking and printing steps noted above (steps S13 and S14).

As described hereinbefore, the RIP 102 shown in FIG. 2 creates and stores job data 103 in the form of bitmap data. The control unit 110 in the printing machine downloads this job data 103 from the RIP 102 through the LAN, and stores the job data 103 in a storage device such as RAM 112, a hard disk or the like. The control unit 110 takes this downloading action at predetermined intervals or at appropriate times when the printing machine is in no-load condition. Thus, a downloading operation may be on standby when the printing machine is at high load.

In this state, a job selecting step is executed first (step S21). This job selecting step (step S21) is similar to the job selecting step (step S11) shown in FIG. 3.

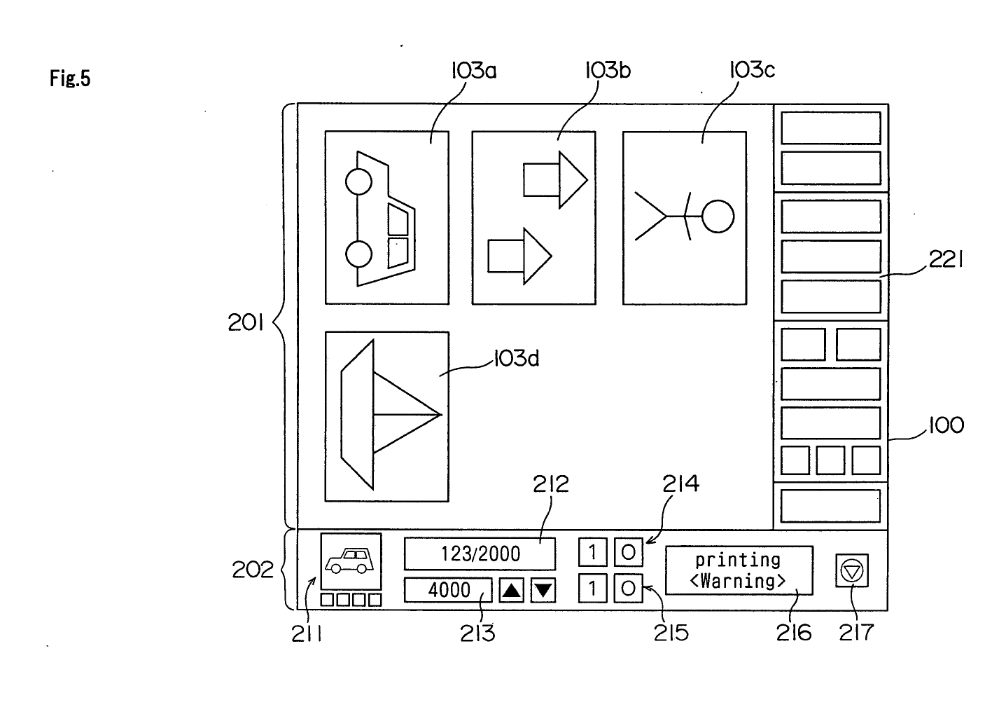

FIG. 5 is a schematic view showing a display screen 100 of the control panel 99 for the job selecting step.

While performing a printing process, the printing machine according to this invention displays, on the display screen 100 of the control panel 99, both a printing state window 202 showing a state of the printing process currently in progress and a setting window 201 for setting printing conditions relating a printing job to be performed afterward.

In the job selecting step, the setting window 201 shows a plurality of job data 103a, 103b, 103c and 103d downloaded from the RIP 102 and stored in the printing machine, and various setting keys 221. From among these job data 103a, 103b, 103c and 103d, the operator selects a job data to be printed next (e.g. job data 103a in this embodiment).

On the other hand, the printing state window 202 is displayed on a lower portion of the display screen 100 of the control panel 99. This printing state window 202 is constantly displayed during printing processes. The printing state window 202 includes an indicator 211 showing attached states of the printing plates, an indicator 212 showing the number of prints made, a printing rate indicator 213, a rotation start indicator 214, a printing start indicator 215, an alarm indicator 216 turned on in time of abnormality or in time of need for maintenance, and an emergency stop indicator 217.

In this embodiment, the indicator 211 showing attached states of the printing plates indicates which of the YMCK color plates are being used. This indicator 211 includes four rectangular boxes arranged in lower positions to be lit when the respective YMCK printing plates are used. The four boxes are lit individually to indicate that the number of prints actually made exceeds (or approaches) a predetermined number of prints endurable by the printing plates. Thus, when a printing process is carried out with certain of the printing plates replaced with a new one, a limitation in the number of prints may be checked for each remaining printing plate. It is also possible to provide indications of attached states of the printing plates before images are recorded thereon, completion of image recording thereon, or discharge of the printing plates after a printing process.

The indicator 212 showing the number of prints made indicates the number of prints made by a job concerned. The indicator 212 may show a cumulative total of prints upon instructions of the operator. Where quality is determined as to whether the color of prints is appropriate based on the image data read at the image pickup station 60, numbers of conforming prints and rejected prints may be shown, respectively. When, for example, print density or the like deviates from a predetermined target range at start of a printing process, prints made in such a condition may be counted as rejects.

The rotation start indicator 214 is displayed in the form of buttons for starting and stopping rotation of the printing machine. The printing start indicator 215 is displayed in the form of buttons for instructing whether to start feeding paper to the printing machine in rotation. That is, these indicators 214 and 215, while serving as control buttons, have a function for showing a current operating status of the printing machine. Similarly, the emergency stop indicator 217 has also a function as an emergency stop button. Where input functions and indicating functions are integrated into the touch panel display as described above, an operating status may be grasped and controlled all at once, resulting in improved operability.

Such setting window 201 and printing state window 202 are displayed by the control unit 110 shown in FIG. 2 controlling the controller 115 of the control panel 99. The control unit 110 and controller 115 shown in FIG. 2 constitute a display control device 120 for simultaneously displaying, on the control panel 99 during a printing process, both the printing state window 202 showing a state of the printing process currently in progress and the setting window 201 for setting printing conditions relating to a printing job to be performed afterward.

Referring to FIG. 4 again, a job setting step is executed next (step S22).

This job setting step (step S22) is similar to the job setting step (step S12) shown in FIG. 3.

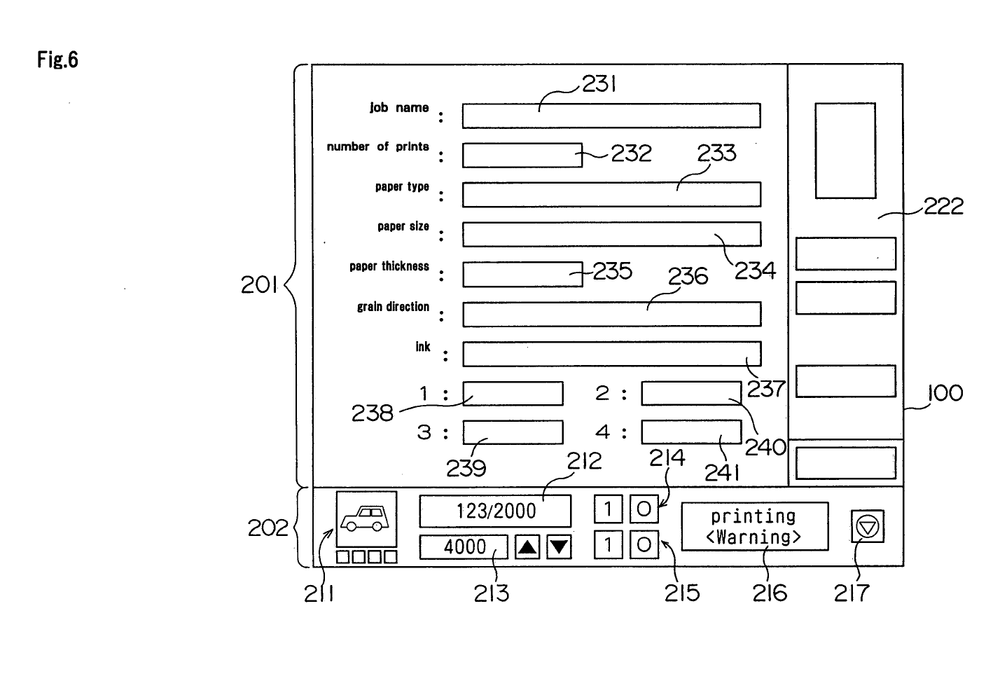

FIGS. 6 through 8 are schematic views showing the display screen 100 of the control panel 99 for the job setting step.

In this setting step, as shown in FIG. 6, the setting window 201 first displays a printing information setting window for setting printing information such as information on printing paper and inks and the number of prints. Specifically, this window includes a job name input box 231, a number of prints input box 232, a paper type input box 233, a paper size input box 234, a paper thickness input box 235, a paper grain direction input box 236, an ink type input box 237, ink information input boxes 238, 239, 240 and 241, and various setting keys 222. During a printing process, the operator may set printing information for a next job by using this printing information setting window.

In this state also, the printing state window 202 displays the indicator 211 showing attached states of the printing plates, indicator 212 showing the number of prints made, printing rate indicator 213, rotation start indicator 214, printing start indicator 215, alarm indicator 216 turned on in time of abnormality or in time of need for maintenance, and emergency stop indicator 217.

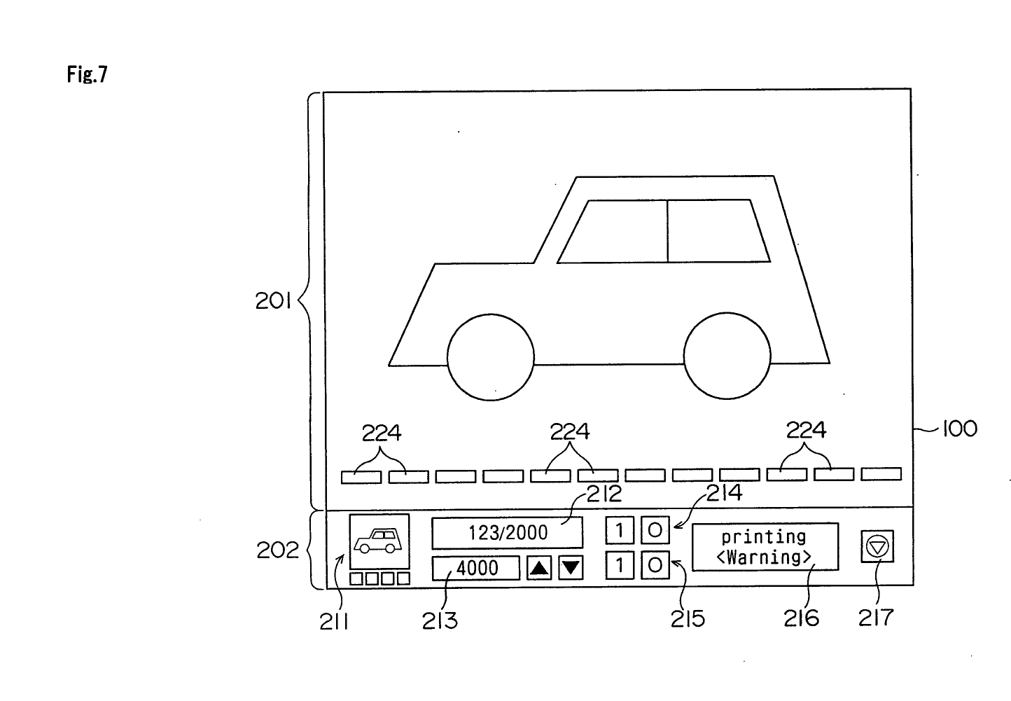

In the setting step, as shown in FIG. 7, the setting window 201 displays also a platemaking information setting window for setting platemaking information. This platemaking information setting window shows an image to be printed, along with detecting patches 224 for use in controlling the feed rates of inks and water in the printing machine. During a printing process, the operator may set platemaking information such as settings of the detecting patches 224 and other platemaking conditions for a next job by using this platemaking information setting window.

In this state also, the printing state window 202 displays the indicator 211 showing attached states of the printing plates, indicator 212 showing the number of prints made, printing rate indicator 213, rotation start indicator 214, printing start indicator 215, alarm indicator 216 turned on in time of abnormality or in time of need for maintenance, and emergency stop indicator 217.

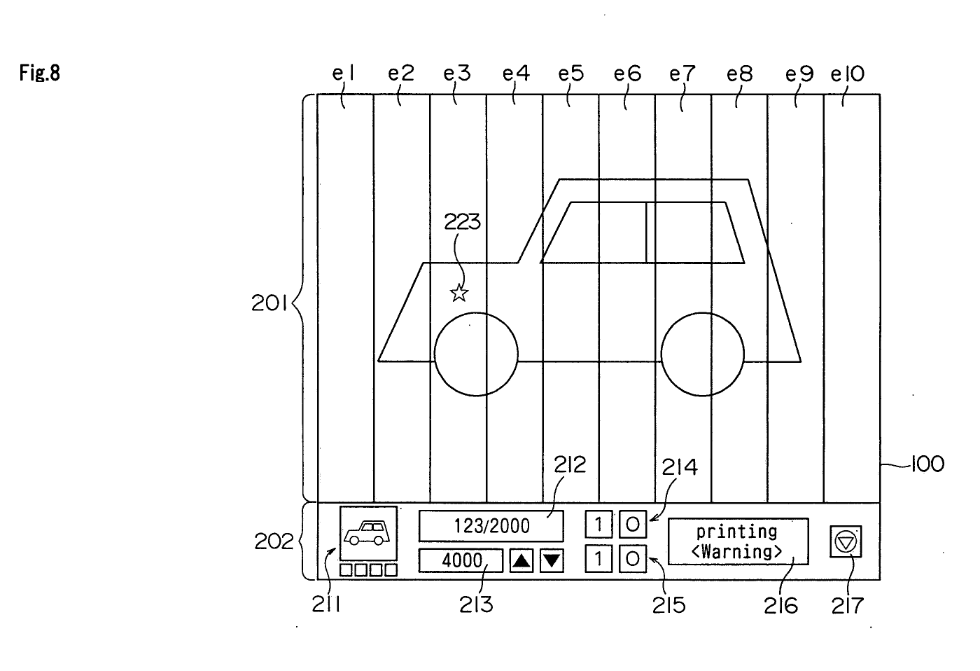

In the setting step, as shown in FIG. 8, the setting window 201 displays also a color control information setting window for setting a representative point 223 for use in color control. This representative point 223 is a point showing a color characterizing the image on prints and used in order to control the color of the image. This color control information setting window shows areas (ten areas e1-e10 in this embodiment) corresponding to ink keys of the ink feeders in the printing machine. During a printing process, the operator sets platemaking information such as settings of a representative point, e.g. position and target color values or color densities of the representative point, and other platemaking conditions by using this color control information setting window. While color is controlled based on a representative point in this embodiment, color control and density control may be carried out by using well-known color control patches.

In this state also, the printing state window 202 displays the indicator 211 showing attached states of the printing plates, indicator 212 showing the number of prints made, printing rate indicator 213, rotation start indicator 214, printing start indicator 215, alarm indicator 216 turned on in time of abnormality or in time of need for maintenance, and emergency stop indicator 217.

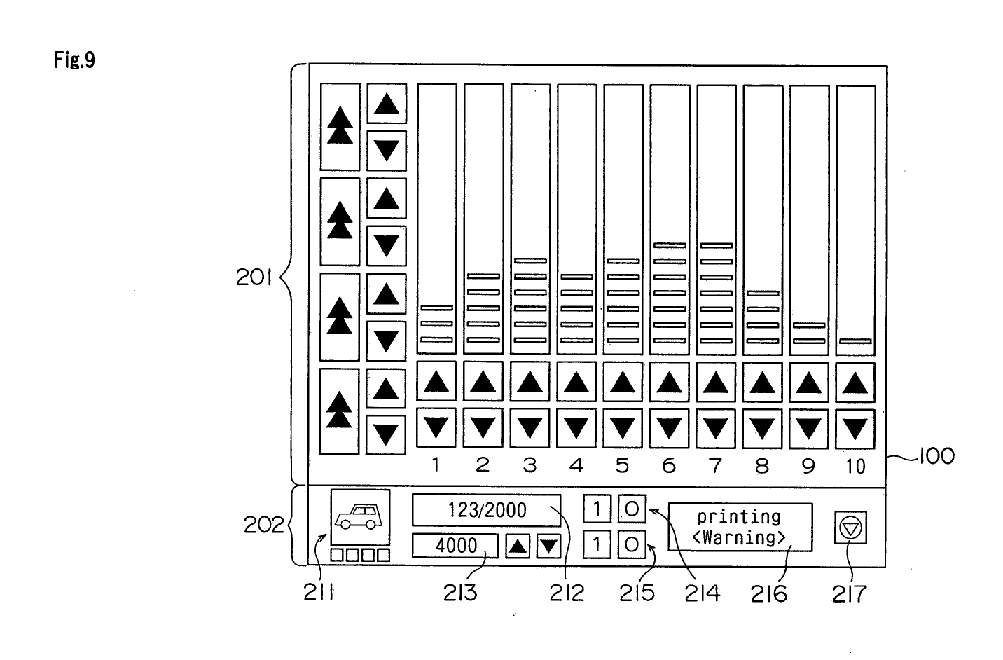

The setting window 201 shown in FIGS. 6 through 8 for use in setting printing conditions for a printing job also displays, as shown in FIG. 9, an ink feed rate display window for use in time of ink feed rate adjustment. This ink feed rate display window is used to adjust an ink feed rate for each of the areas e1-e10 shown in FIG. 8 corresponding to the ink keys. During a printing process, the operator may not only adjust the ink feed rates for the printing process currently in progress, but make an ink preset adjustment for a next job (i.e. set opening degrees of the ink keys before start of a printing process) by using the ink feed rate display window.

In this state also, the printing state window 202 displays the indicator 211 showing attached states of the printing plates, indicator 212 showing the number of prints made, printing rate indicator 213, rotation start indicator 214, printing start indicator 215, alarm indicator 216 turned on in time of abnormality or in time of need for maintenance, and emergency stop indicator 217.

Referring to FIG. 4 again, when the job setting step (step S22) is completed, checking is made whether a printing job remains to be done after the job just set (step S23). When a further printing job remains, steps S21 and S22 are repeated to make settings for the further printing job. When no job remains, the operation is ended.

When no further job remains or when settings for a next job are not performed during the current printing job, only the printing state window 202 may be displayed as enlarged to full screen. In this case, a printing status may be displayed in greater detail, or a window may be displayed for inputting various instructions during the printing job. Further, printed images picked up at the image pickup station 60 may be displayed successively for checking by the operator.

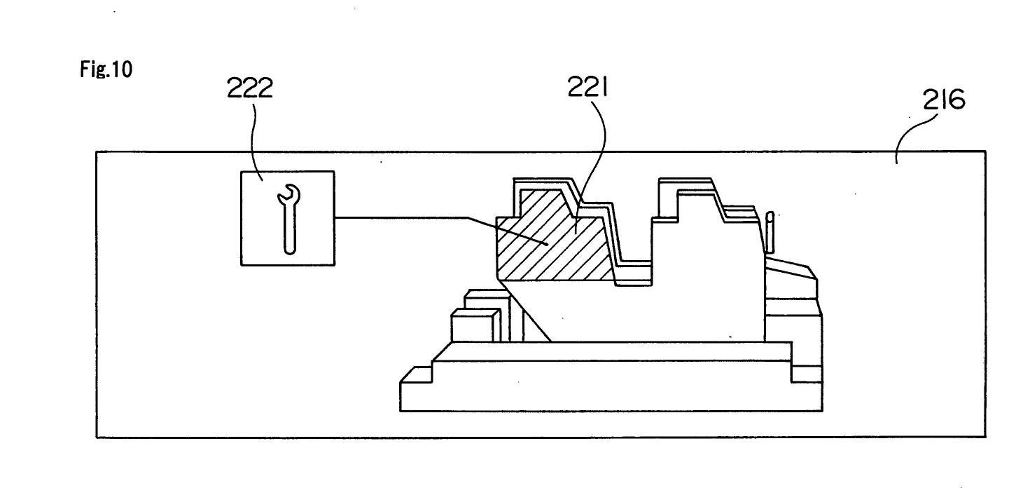

FIG. 10 is a view showing the alarm indicator 216 in the printing state window 202.

When an abnormality occurs with the printing machine, or when maintenance is needed, the alarm indicator 216 shows a stereoscopic image based on the stereoscopic image data stored by the CPU 113 and corresponding to an abnormal part and abnormal condition detected by a sensor 104 or a maintenance part and particulars of the maintenance. When, for example, an abnormality has occurred with the printing machine, as shown in FIG. 10, an abnormal part 221 is shown in hatches, with a mark 222 corresponding to an abnormal condition.

With a stereoscopic image corresponding to an abnormal part and abnormal condition or a maintenance part and particulars of the maintenance displayed as described above, the operator may grasp exactly the abnormal part and abnormal condition or the maintenance part and particulars of the maintenance of the printing machine.

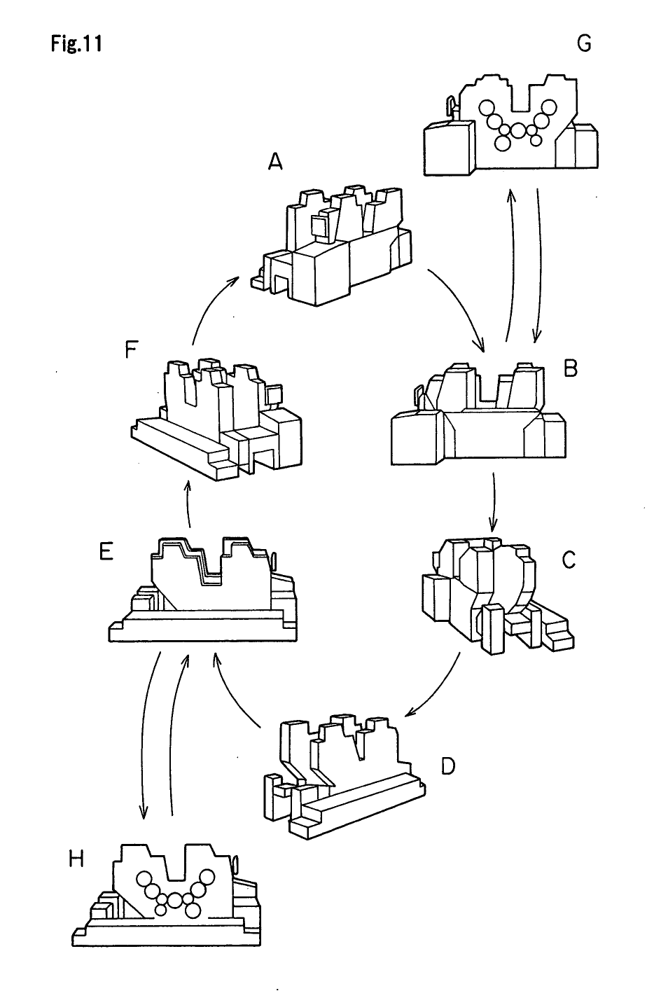

FIG. 11 is a view showing parts of the stereoscopic image of the printing machine appearing in the alarm indicator 216 in the printing state window 202.

In FIG. 11, A shows a stereoscopic image of the printing machine seen from a left-hand front position in FIG. 1, B shows a stereoscopic image of the printing machine seen from a front position in FIG. 1, and C shows a stereoscopic image of the printing machine seen from a right-hand front position in FIG. 1. D shows a stereoscopic image of the printing machine seen from a right-hand rear position in FIG. 1. E shows a stereoscopic image of the printing machine seen from a rear position in FIG. 1. F shows a stereoscopic picture image of the printing machine seen from a left-hand rear position in FIG. 1. G shows a perspective image of the printing machine corresponding to the image B with the interior seen through. H shows a perspective image of the printing machine corresponding to the image E with the interior seen through. Image data for images A through H are stored in the ROM 111 or RAM 112. The ROM 111 or RAM 112 also shores stereoscopic images and perspective images of the printing machine seen from angles other than A through H (i.e. images of further subdivided variations between A and H).

When, for example, the printing machine has a plurality of abnormal parts or maintenance parts, the alarm indicator 216 displays, by turns, stereoscopic images corresponding to the abnormal parts or maintenance parts. In this embodiment in particular, as shown in FIG. 11, the alarm indicator 216 successively displays the stereoscopic images A through F corresponding to a plurality of abnormal parts or maintenance parts. Thus, the printing machine is displayed as rotated phase by phase. As a result, even when a plurality of abnormal parts or maintenance parts are present in the printing machine, the operator may grasp exactly the abnormal parts and abnormal conditions or maintenance parts and particulars of the maintenance. Such a stereoscopic presentation enables the operator to determine quickly which parts should be dealt with, particularly with an apparatus such as an offset press that has a construction asymmetrical in the right and left direction and in the front and rear direction, with operating planes extending in two or more directions, and maintenance work required circumferentially of the apparatus.

When an abnormal part or a maintenance part is present inside the printing machine, the alarm indicator 216 displays a perspective image. When abnormal parts or maintenance parts are present both outside and inside the printing machine, the alarm indicator 216 displays, by turns, both a stereoscopic image or images and a perspective image or images. When, for example, abnormal parts are present both in the range shown in B in FIG. 11 and inwardly of this range, the alarm indicator 216 displays, by turns, both the image B and the image G which is a see-through image of the interior of the image B. When abnormal parts are present both in the range shown in E in FIG. 11 and inwardly of this range, the alarm indicator 216 displays by turns both the image E and the image H which is a see-through image of the interior of the image E. Thus, even when abnormal parts or maintenance parts are present both outside and inside the printing machine, the operator may grasp exactly the abnormal parts and abnormal conditions or maintenance parts and particulars of the maintenance.

In this state also, the printing state window 202 displays the indicator 211 showing attached states of the printing plates, indicator 212 showing the number of prints made, printing rate indicator 213, rotation start indicator 214, printing start indicator 215 and emergency stop indicator 217.

In the embodiment described above, the ROM 111 or RAM 112 stores stereoscopic images and perspective images of the printing machine seen from various angles. Alternatively, the ROM 111 or RAM 112 may store 3D polygon data of the entire printing machine, with stereoscopic images of the printing machine seen from given angles displayed by computation. In this case also, appropriate stereoscopic images corresponding to a plurality of abnormal conditions are selected for display.

In the embodiment described above, the single control panel 99 of the touch panel type acts as the input device and display device of this invention. Instead, the input device may be a mouse and/or a keyboard, and the display device may be a CRT. The display device may include a plurality of displays.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2004-20753 filed in the Japanese Patent Office on Jan. 29, 2004, and Japanese Patent Application No. 2004-201960 filed in the Japanese Patent Office on Jul. 8, 2004, the entire disclosure of which is incorporated herein by reference.

1. A printing machine for making printing plates by recording thereon images based on image data, and printing the images on printing paper by transferring inks applied to the printing plates to the printing paper, said printing machine comprising:
an input device for setting printing conditions for a printing job in relation to said image data;
a display device; and
a display control device for causing said display device to display simultaneously, during a printing process, both a printing state screen showing states of the printing process in progress and a setting screen for setting printing conditions for a printing job to be carried out afterward.

2. A printing machine as defined in claim 1, wherein said setting screen includes any of a job selection screen for selecting the printing job to be carried out afterward, a printing information setting screen for setting printing information such as information on the printing paper and the inks and the number of prints, a platemaking information setting screen for setting platemaking information, and a color control information screen for setting color control information.

3. A printing machine as defined in claim 1, wherein said printing state screen includes a completed number of prints indicator and an alarm indicator.

4. A printing machine as defined in claim 1, wherein said input device and said display device comprise a touch type control panel.

5. A printing machine as defined in claim 4, wherein said printing state screen includes a completed number of prints indicator and an alarm indicator.

6. A printing machine as defined in claim 4, wherein said display control device causes said display device to display additionally and simultaneously buttons for starting and stopping operation of the printing machine.

7. A printing machine as defined in claim 1, further comprising:
a control device for controlling a printing operation of said printing machine, and detecting abnormal parts and abnormal conditions occurring in the printing machine and parts requiring maintenance and particulars of the maintenance in the printing machine; and
a storage device for storing a plurality of stereoscopic image data of said printing machine related with the abnormal parts and abnormal conditions and the parts requiring maintenance and particulars of the maintenance detected by said control device;
wherein said display control device is arranged to select, from the plurality of stereoscopic image data stored in said storage device, and cause said display device to display, on said printing state screen, a stereoscopic image corresponding to an abnormal part and abnormal condition or a part requiring maintenance and particulars of the maintenance detected by said control device.

8. A printing machine as defined in claim 7, wherein said display control device is arranged to cause said display device, when a plurality of abnormal parts or parts requiring maintenance are present, to display, by turns, stereoscopic images corresponding to the abnormal parts or the parts requiring maintenance.

9. A printing machine as defined in claim 7, wherein said display control device is arranged to cause said display device, when a plurality of abnormal parts or parts requiring maintenance are present, to display continuously stereoscopic images corresponding to the abnormal parts or the parts requiring maintenance, in a way to rotate the images of the printing machine.

10. A printing machine as defined in claim 7, wherein said storage device stores perspective image data of said printing machine for displaying interiors as seen through, said display control device being arranged to cause said display device to display a perspective image when said abnormal part or said part requiring maintenance is present inside said printing machine.

11. A printing machine as defined in claim 10, wherein said display control device is arranged to cause said display device to display, by turns, both said stereoscopic image and said perspective image when said abnormal part or said part requiring maintenance is present both outside and inside said printing machine.

12. A printing machine as defined in claim 7, wherein said setting screen includes any of a job selection screen for selecting the printing job to be carried out afterward, a printing information setting screen for setting printing information such as information on printing paper and ink and the number of prints, a platemaking information setting screen for setting platemaking information, and a color control information screen for setting color control information.

13. A printing machine as defined in claim 7, wherein said printing state screen includes a completed number of prints indicator.

14. A printing machine as defined in claim 7, wherein said display device comprises a touch type control panel.

15. A printing machine as defined in claim 14, wherein said display control device causes said display device to display simultaneously buttons for starting and stopping operation of the printing machine.
